(19) United States
(12) Patent Application Publication
(10) Pub. No.: US 2010/0148445 A1
(43) Pub. Date: Jun. 17, 2010

(54) BALL DELIVERY AND SPORTS APPARATUS

(75) Inventor: Geoff Wilkins, Walsall (GB)

Correspondence Address: Zilka-Kotab, PC, P.O. BOX 721120, SAN JOSE, CA, 95172-1120, US

(73) Assignee: SOCCER CIRCUS (BRAEHEAD) LLP, Braehead, PA (US)

(21) Appl. No.: 12/442,504

(22) PCT Filed: Sep. 21, 2007
(86) PCT No.: PCT/GB2007/003579

§ 371 Date: Mar. 1, 2010

(30) Foreign Application Priority Data
Sep. 22, 2006 (GB) 0618702.5
Oct. 9, 2006 (GB) 0620133.9

(51) Int. Cl. A63B 47/00; B65G 47/14; A63B 63/00

(52) U.S. Cl. 273/371; 198/470.1; 198/506; 198/550.4

(57) ABSTRACT

An apparatus for delivering balls is disclosed. The apparatus has a pair of conveyors for balls (specifically footballs) that follow a conveyor path. There is a collection area or sump that receives balls and the path of the conveyor passes through the sump area at an angle inclined to the horizontal. The exit to the sump has a travel limiting device to prevent any balls from leaving sump area unless they are correctly engaged with said conveyor. The balls are delivered to a sports apparatus for use as part of a game or sports themed attraction.

The present invention relates to a ball delivery apparatus and also to a sports apparatus. It relates particularly, but not exclusively, to an apparatus for delivering soccer balls as part of a soccer training and/or entertainment apparatus.

When creating an attraction for the public, it is often the personnel costs which form the greatest, or at least a significant, part of the running costs of the attraction. It is therefore important to be able to create such an attraction which provides maximum interest and interaction for visiting members of the public with a minimal need for paid staff to be present on site to run the attraction. For a sports themed attraction, this therefore requires any balls which are used as part of the attraction can be handled consistently and repeatedly without operator assistance or interference.

Sports balls present problems for ball handling apparatus since they are often air filled and therefore compressible and have surfaces designed to interact with objects other than other balls. For example, a soccer ball, (hereinafter referred to as a football) is only designed to be handled or kicked and therefore in the production of such balls little or no consideration is given to the interaction of one football with another. The surface of a football is designed to be kicked and caught and it is, for example, important that a players boot is able to engage a football so as to cause it to spin as it is kicked and that a goalkeeper is able to easily catch a ball. As a result, when the surface of two footballs are brought together, the surface of one ball does not slide easily over the surface of the other and in a ball delivery apparatus, they are therefore inclined to jam together. This can therefore result in at least inconsistent delivery of balls or damage to the apparatus.

Sports training games, whether used as part of a sports themed attraction or used as part of a training programme, need to be made interesting in order to encourage their use. However, normal methods of creating such interest require input from people such as a trainer. They are not only able to increase the variety of interaction but can also be used to determine such things as whether the game is being played properly, to keep a score, whether the game is being played fast enough and whether the user is improving. Such training methods are therefore not suitable at a public attraction as this will significantly increase running costs.

Preferred embodiments of the present invention seek to overcome the above disadvantages of the prior art.

According to an aspect of the present invention there is provided an apparatus for delivering balls, the apparatus comprising:—

at least one conveyor for conveying a plurality of balls, the or each conveyor following a respective path;
at least one collection portion for receiving said balls, wherein said path at least partially passes though said collection portion at an angle inclined to the horizontal, said collection portion comprising ball travel limiting means for preventing a ball from leaving said collection portion unless it is correctly engaged with said conveyor.

By providing a ball delivery apparatus in which part of the path of a conveyor passing through a ball collection portion is inclined from the horizontal and has a ball travel limiting means, the advantage is provided that if an excess of balls gets caught onto the conveyor, the excess of balls are prevented from passing out of the collection portion and are pushed back into the collection portion thereby filling further sections of the conveyor and ensuring consistent and repeatable delivery of balls without significant or even any operator interference.

In a preferred embodiment the conveyor comprises a plurality of supports connected thereto for supporting and/or guiding said balls.

In another preferred embodiment the ball travel limiting means comprises a portion of said path, within said collection portion, wherein said angle of said path in said portion increases such that said balls fall from said conveyor unless they are correctly engaged with said conveyor.

In a further preferred embodiment at least part of said portion of said path passing through said collection portion follows a substantially curved path with the angle of inclination changing from substantially horizontal to substantially vertical

By the ball travel limiting means being a portion of the path which is inclined at such a steep angle that balls are unable to remain on the conveyor when they are not correctly engaged with the conveyor, in particular between supports on the conveyor, the advantage is provided that the balls are falling one over the other only under the force of gravity and are not being pushed against an obstacle. The balls are therefore simply falling back one over the other and are less likely to become jammed one against another or against a part of the apparatus.

The apparatus may further comprise a pair of conveyors adapted to follow respective paths wherein at least a portion of said paths passing through said collection portion are separated by a first wall.

The apparatus may also further comprise second walls aligned substantially parallel to the path of said conveyor through at least part of said collection portion, wherein at least part of said second walls are taller that an equivalent portion of said first wall.

By providing a pair of conveyors, which typically follow mirror image paths of each other, and with this pair of conveyors passing through at least part of the collection portion and separated by a first wall which is lower than second walls on the opposite sides of the conveyors from the first wall, the advantage is provided that if a large number of balls mount up on one side of the collection portion and therefore fill one conveyor quicker than the other, the second wall will incline the balls to move over towards the less filled conveyor, thereby providing an even fill.

According to another aspect of the present invention, there is provided a method of delivering balls, comprising the steps of:—

receiving in a collection portion of an object delivery apparatus a plurality of balls;
conveying at least one conveyor along a path passing at least partially through said collection portion at an angle inclined to the horizontal; and
preventing a ball from leaving said collection portion unless it is correctly engaged with said conveyor.

The balls may be prevented from leaving said collection portion, by increasing said angle along said path such that said balls fall from said conveyor unless they are correctly engaged with said conveyor.

In a preferred embodiment the portion of said path passing through said collection portion follows a substantially curved path with the angle of inclination changing from substantially horizontal to substantially vertical.

According to a further aspect of the present invention there is provided a ball delivery device apparatus comprising:—

at least one conveyor for conveying at least one ball, the conveyor following a first path;
at least one direction changer for diverting the or each ball from following said first path, at least one said direction changer comprising at least one first rotatable ball engaging member positioned to direct said ball from said first path; and
at least one delivery device for delivering the or each ball.

By providing a ball delivery device with a conveyor and a direction changer for diverting balls from the conveyor, the direction changer having rotatable ball engaging members, the advantage is provided that as the balls engage the direction changer, the rotatable ball engaging members rotate thereby allowing the ball to not rotate relative the conveyor other than to be simply pushed from the conveyor. If the ball engaging members did not rotate, the ball would be forced to rotate either relative to the conveyor or relative to the direction changer. This would lead to damage to the conveyor and/or to inconsistent delivery of the ball to the delivery device.

In a preferred embodiment said delivery device comprises at least one chute.

The apparatus may further comprise at least one second rotatable ball engaging member adapted to engage the or each ball as they leave said conveyor and pass to said delivery device.

By providing further rotatable ball engaging members to engage the ball as it leaves the conveyor and passes to the delivery device, the advantage is provided that the ball is only ever engaged with a single surface which is not able to rotate. In this instance the conveyor, or support on the conveyor, is not able to rotate and if the second rotatable ball engaging members were not present there would be a danger that the ball would jam relative to the conveyor. However the second rotatable ball engaging members ensure there is no jamming of the ball and each ball is consistently delivered.

In a preferred embodiment at least one conveyor comprises at least one support for guiding and/or supporting a respective ball.

At least one of the rotatable ball engaging members may comprise a plurality of casters.

At least one of the first rotatable ball engaging members may comprise a pair of lines of casters aligned on either side of said conveyor.

By using a pair of lines of castors, the advantage is provided that castors either side of the conveyor consistently deliver the ball from the conveyor to the delivery device.

According to another aspect of the present invention, there is provided a method of delivering balls comprising the steps of:—

conveying at least one ball on a conveyor, the conveyor following a first path; and
diverting the or each ball from following said first path, using at least one said direction changer comprising at least one first rotatable ball engaging member positioned to direct said ball from said first path.

The or each ball may be diverted to at least one chute.

According to an aspect of the present invention there is provided a ball delivery device comprising:—

at least one feed device for feeding a plurality of balls to a collection portion;
at least one first ball delivery apparatus substantially as defined above;
at least one second ball delivery apparatus substantially as defined above;
wherein said conveyor conveys said balls from at least one said first delivery apparatus to at least one second ball delivery apparatus.

According to another aspect of the present invention there is provided a sports apparatus comprising:—

at least one processor for receiving at least one input signal and producing at least one output signal;
at least one target indicator for indicating at least one target to be engaged by at least one ball, the or each target indicator indicating said target in response to at least one output signal from at least one said processor;
at least one sensor for sensing said sensor, or an area adjacent said sensor, being engaged by at least one ball and said sensor thereby producing at least one first input signal;
at least one result indicator for indicating at least one result in response to at least one second output signal from said processor, wherein said processor produces said second output signal dependent upon at least one said first input signal and at least one said first output signal.

By providing a processor, a target indicator, a sensor and a result indicator and linking them so that the result indicator indicates a result when the ball hits a sensor when its respective target indicator is indicating the target, the advantage is provided that an interesting training programme can be provided for a user with minimal operator interaction. When provided as part of a sports themed attraction, such an apparatus can be operated without operator interaction, thereby reducing operative costs.

In a preferred embodiment at least one target indicator and at least one sensor are located on a vertical surface and/or on a horizontal surface.

By providing the target indicators and sensors in a vertical surface, the apparatus can be used for football shooting practice and by providing them in a horizontal surface they can be used for close ball control or drilling skills practice.

In a preferred embodiment at least one target indicator comprises at least one light emitting device which emits light in response to said first output signal.

In another preferred embodiment at least one said sensor is adapted to produce at least one said input signal in response to a ball being rolled over it.

In a further preferred embodiment at least one said sensor is adapted to produce at least one said input signal in response to a ball being hit against it.

At least one sensor may produce at least one said input signal in response to a change in the amount of light received by said sensor being altered by the position of a ball relative to said sensor.

In a preferred embodiment at least one result indicator comprises at least one light emitting device.

At least one said target indicator and at least one said result indicator may comprise at least one respective light emitting device.

At least one said target indicator may comprise at least one visual display device adapted to display a score.

At least one said processor may produce at least one said second output signal if said first input signal is received from at least one sensor corresponding to at least one respective target indicator which has received at least one first output signal within a predetermined time.

According to a further aspect of the present invention there is provided sports apparatus comprising:—

at least one processor for receiving at least one input signal and producing at least one output signal;
at least one target adapted to be hit by at least one ball and adapted to move between at least one first position and at least one second position in response to at least one output signal from said processor;
at least one sensor for sensing at least one ball hitting a respective target and said sensor thereby producing at least one first input signal;
wherein said processor produces said output signal dependent upon at least one said first input signal.

At least one said sensor may comprise at least one accelerometer.

The first position may be an extended position and the second position may be a retracted position.

According to an aspect of the present invention there is provided a sports apparatus comprising:—

at least one ball delivery apparatus substantially as defined above; and
at least one sports apparatus substantially as defined above.

Preferred embodiments of the present invention will now be described, by way of example only, and not in any limitative sense, with reference to the accompanying drawings in which:—

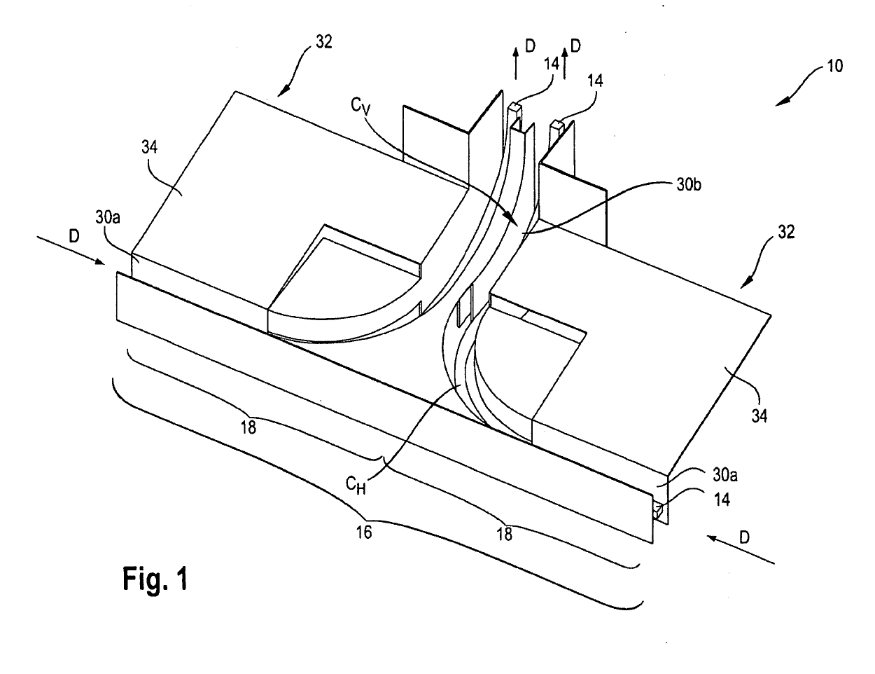

FIG. 1 is a perspective view of a collecting portion of a ball delivery apparatus of the present invention;

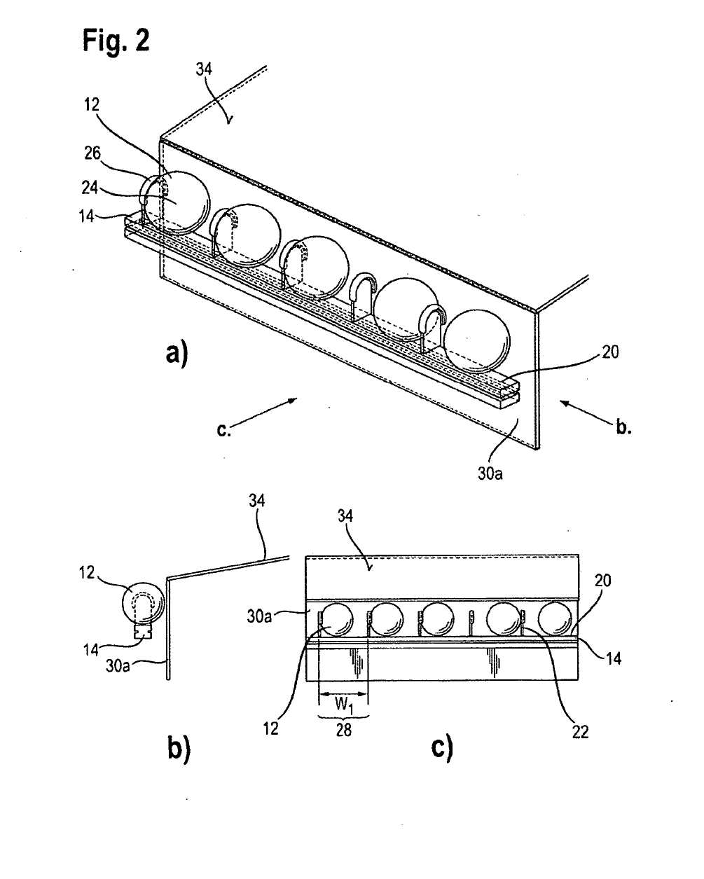

FIGS. 2, 3, and 4 each contain three views o part of a conveyor of a ball delivery apparatus of the present invention with part (a) each figure being a perspective view, part (b) being an end view of the conveyor in part (a) and part (c) being a side view of the conveyor in part (a);

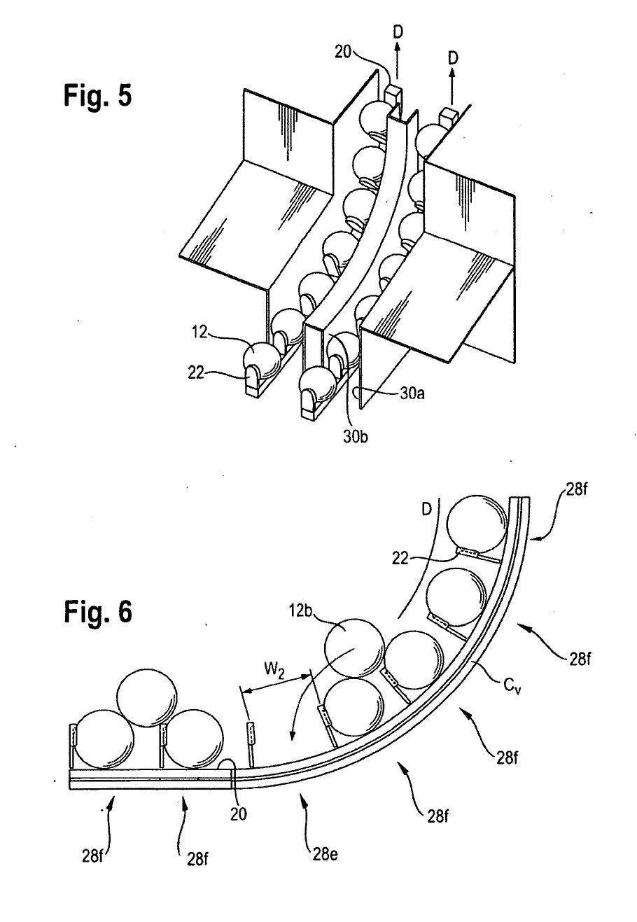

FIGS. 5-10 are views of part of the conveyor of FIG. 1, with FIGS. 5, 7, 9 and 11 being perspective views and FIGS. 8, 6 and 10 being side views;

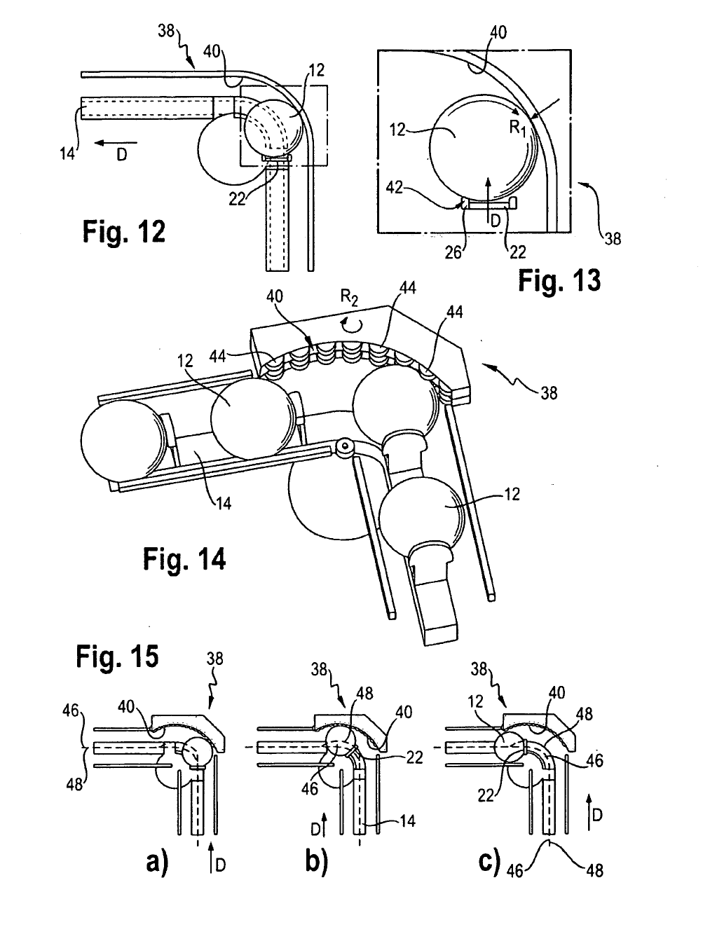

FIGS. 12-15 are views of a corner section of a conveyor of the type used in FIG. 1 with FIG. 14 being a perspective view and FIGS. 12, 13 and 15 being plan views;

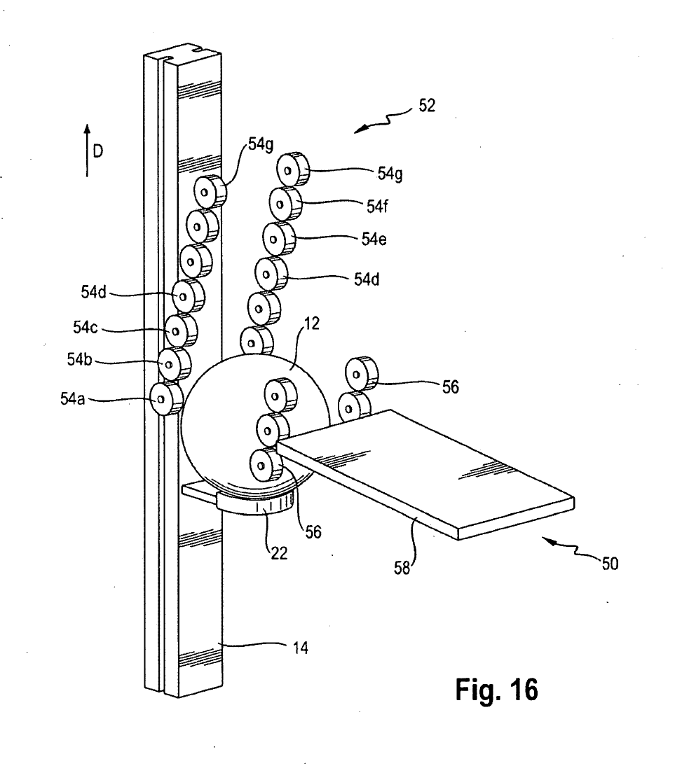

FIG. 16 is a perspective view of a ball delivery apparatus of the present invention;

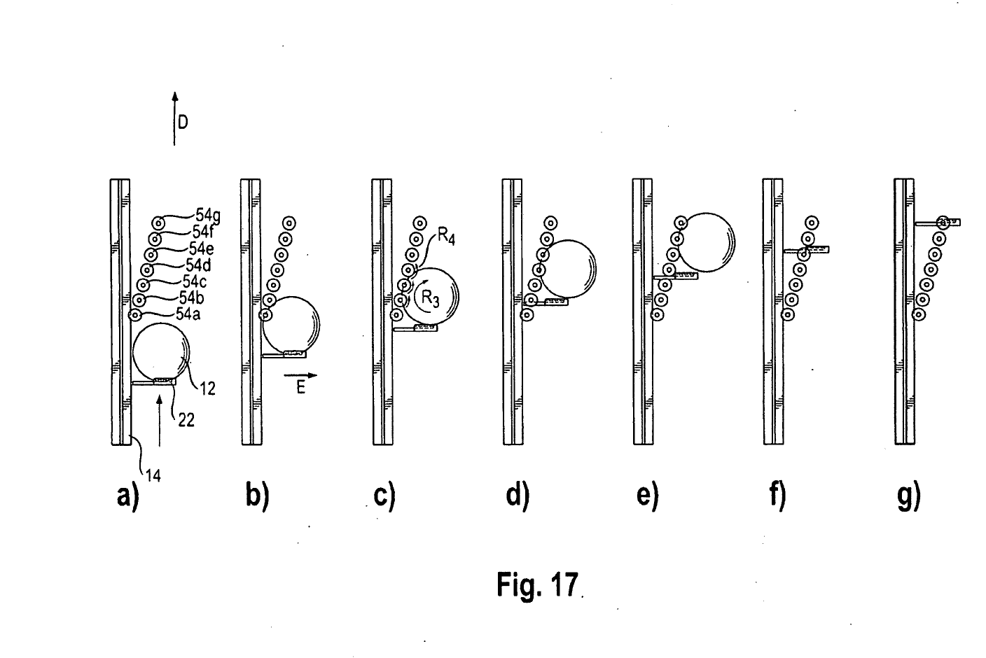

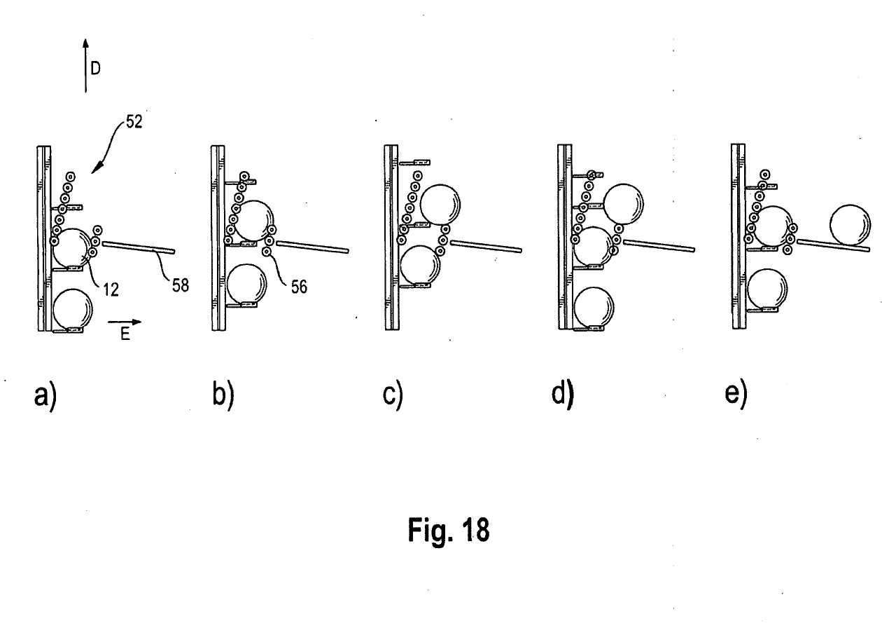

FIGS. 17 and 18 are side views of the apparatus of FIG. 16 showing a ball in several stages of delivery;

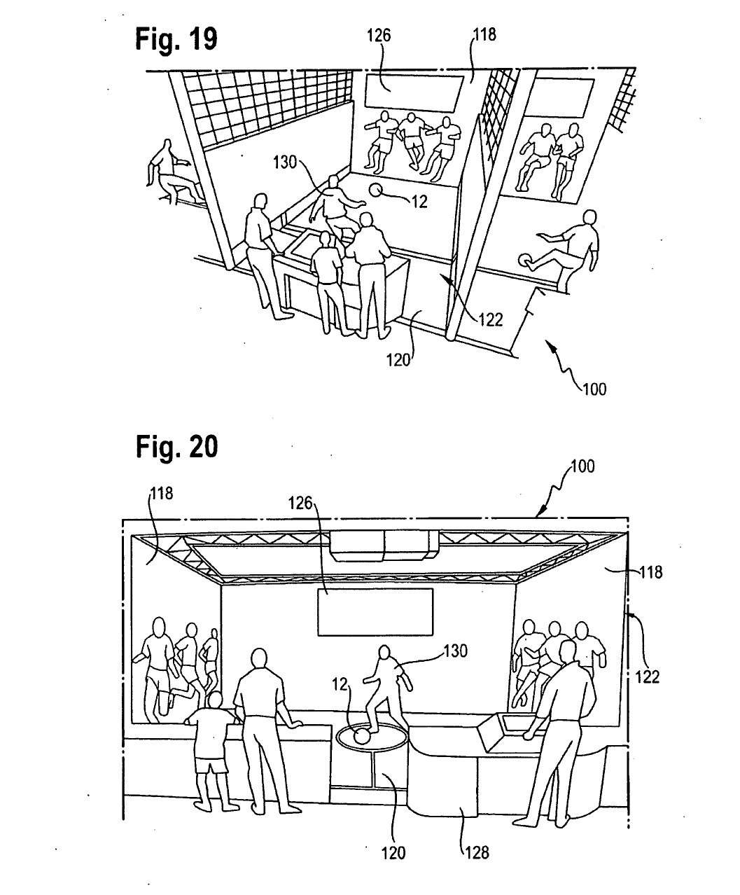

FIG. 19 is a perspective view of a sports apparatus of the present invention;

FIG. 20 is a perspective view of another sports apparatus of the present invention;

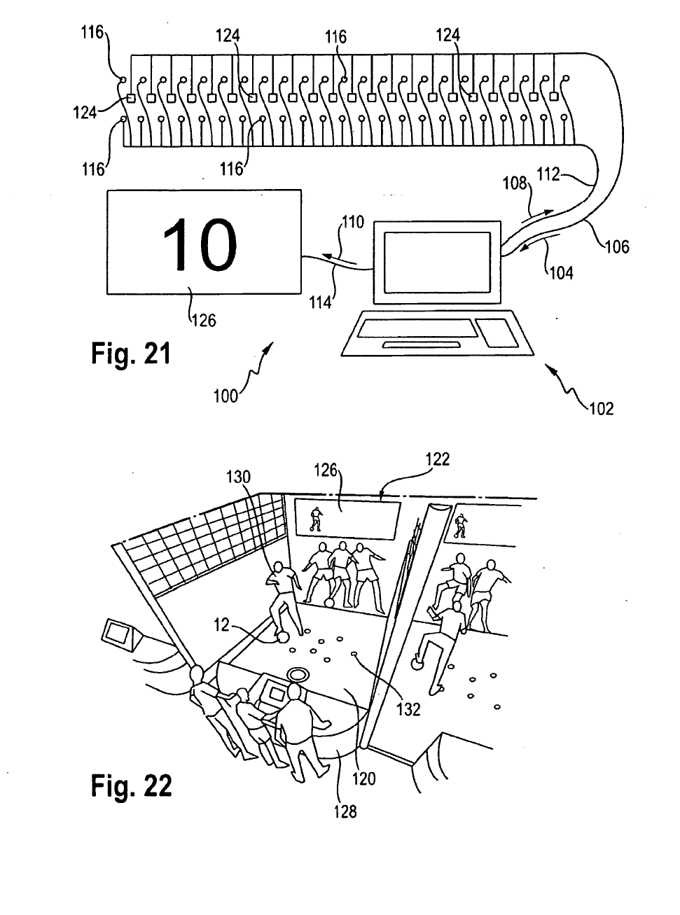

FIG. 21 is a schematic representation of the apparatus of FIGS. 19 and 20;

FIG. 22 is a perspective view of a further sports apparatus of the present invention;

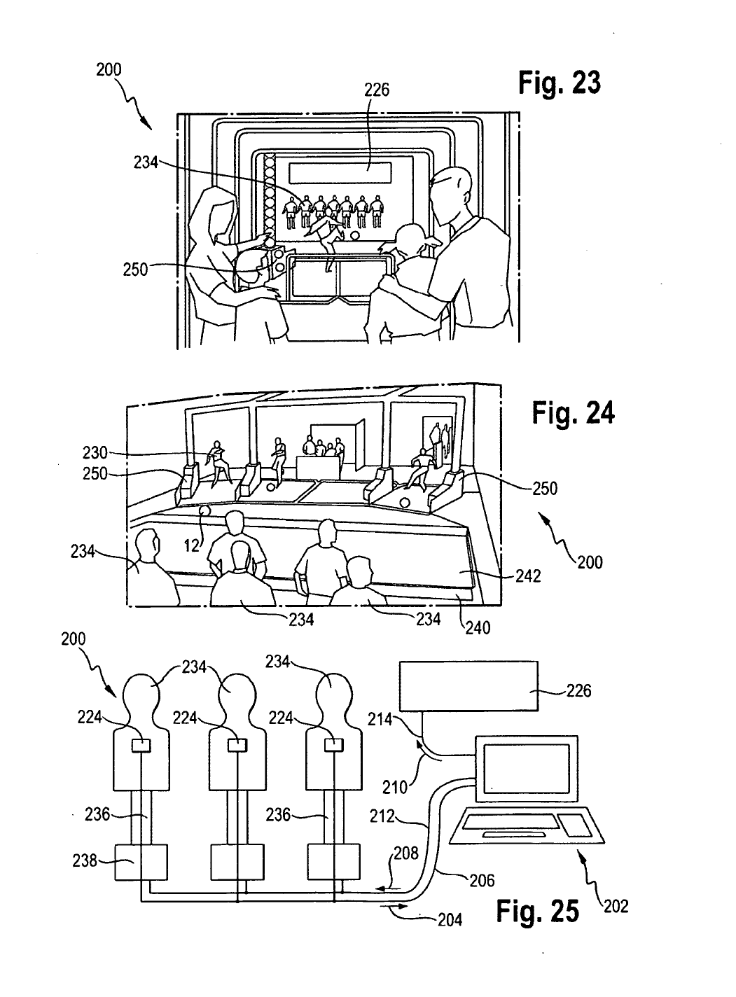

FIGS. 23 and 24 fare perspective views from opposite directions of a sports apparatus of the present invention; and

FIG. 25 is a schematic representation of the apparatus of FIGS. 23 and 24.

Referring to FIGS. 1-11, an apparatus 10 for delivering balls 12 which could for example be footballs, includes a conveyor 14 for conveying a plurality of balls 12. The conveyor is an endless conveyor following a looped path. The apparatus includes a collection portion or collection zone 16 through which a portion 18 of the path of conveyor 14 passes. In the example shown in FIG. 1, the apparatus 10 includes two conveyors 14 which follow paths that are mirror images of each other with the conveyors travelling in direction D. As a result, the right hand, conveyor as viewed in FIG. 1 from above, travels in a clockwise direction, with the left hand conveyor travelling in an anticlockwise direction. As the conveyor 14 enters the collection portion 16 it travels in a horizontal plane and passes through a curve Cᵥ whilst remaining in a horizontal plane before following a curved path out of the horizontal plane and exiting the collection portion travelling in a substantially vertical direction this curve Cᵥ remains in a vertical plane. As a result, the conveyor must be able to move within two degrees of freedom so as to accommodate this curving within a horizontal and within a vertical plane. Such conveyors are well known to persons skilled in the art.

As will be explained in greater detail below, the transition from horizontal to vertical movement of the conveyor 14 prevents any balls 12 from exiting the collection portion 16 of apparatus 10 unless they are correctly engaged with the conveyor and therefore provides a ball travel limiting means. The conveyor 14 has a conveyor surface 20 which the balls engaged with when travelling in the horizontal plane (see FIGS. 2, 3 and 4) and supports 22 which the balls 12 engaged with when the conveyor is travelling in a vertical direction (see FIGS. 17 and 18). Clearly as the conveyor passes from a horizontal to vertical path, the ball will partially rest on the conveyor surface 20 and partially on the support 22. The height H, of the support 22 is more than the average radius of the ball 12 but less than the average diameter. Each support has a semi-circular outer end 24 with a rim 26 running around the outside which prevents the ball from rolling off the support 22 when the conveyor 14 is travelling in a vertical direction.

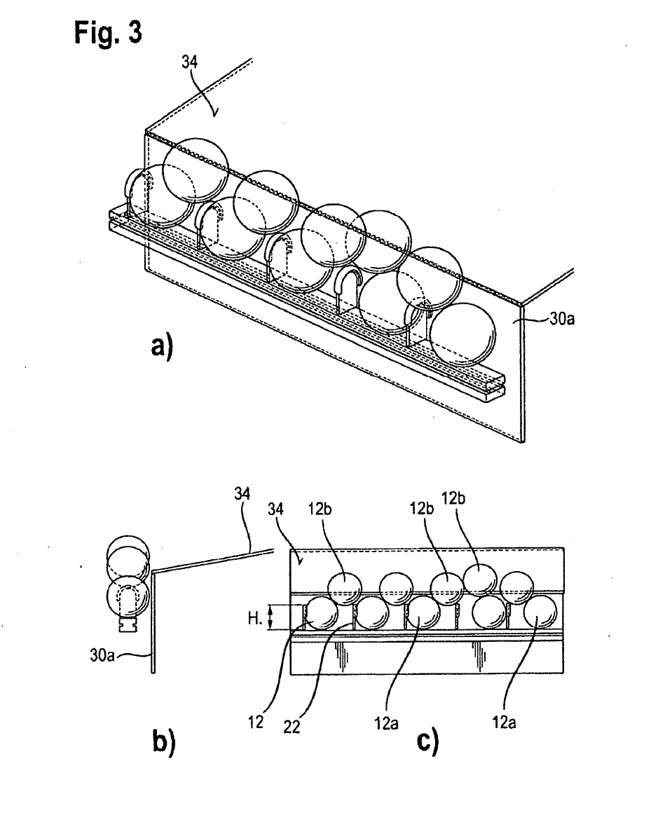

When the conveyor 14 is following a linear path (as shown in FIGS. 2-4), the distance between two supports (w₁) is more than the diameter of a ball but less than twice that diameter. Typically the distance w₁ is one and a half times the average ball diameter. As a result, each section 28 of conveyor 14, which is defined by two adjacent supports 22, accommodates a single ball. As can be seen in FIG. 3, when more than one ball 12 attempts to enter a conveyor section 28 only a single ball 12a enters each conveyor section 28 with any additional balls 12b being located on top and resting against the correctly positioned balls 12a and the supports 22. The conveyor is bound on either side by walls 30a and 30b which prevent the correctly positioned balls 12a from rolling from the conveyor 14 until they are needed. As the conveyor bends through a vertical curve Cᵥ the outer ends 24 of the supports 22 move closer to an adjacent support to a distance W₂, which is less than W₁ but still larger than the average diameter of the ball.

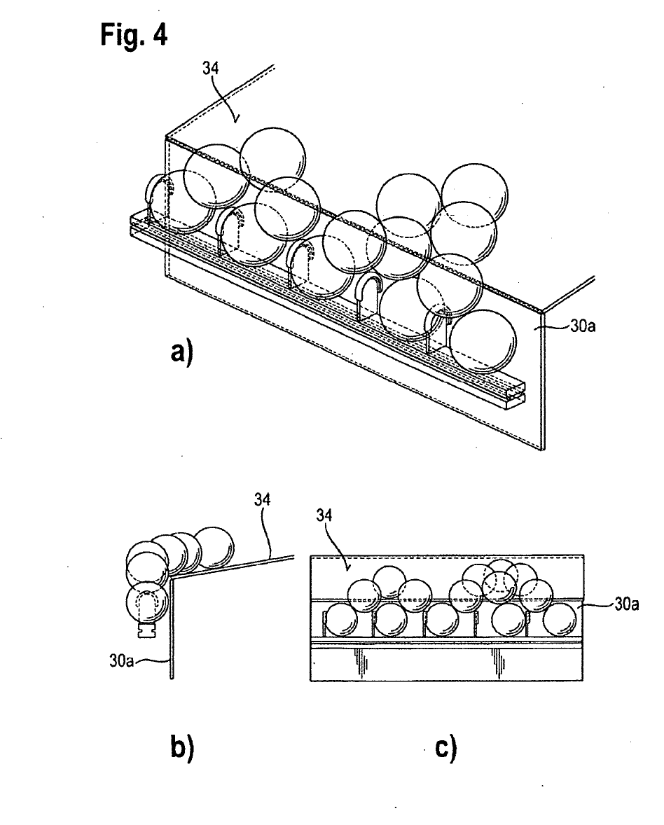

Balls enter the collection portion 16 at entrance points indicated at 32 and roll down an inclined surface 34 towards conveyor 14. As can be seen from FIG. 4, if the number of balls entering the collection portion is significantly greater than the number leaving, then the balls begin to pile up on surface 34, unable to engage the conveyor surface 20 until the balls in conveyor sections 28 have exited the collection portion. This shape of conveyor causes the balls to preferentially fall down a single conveyor before falling across to an adjacent conveyor.

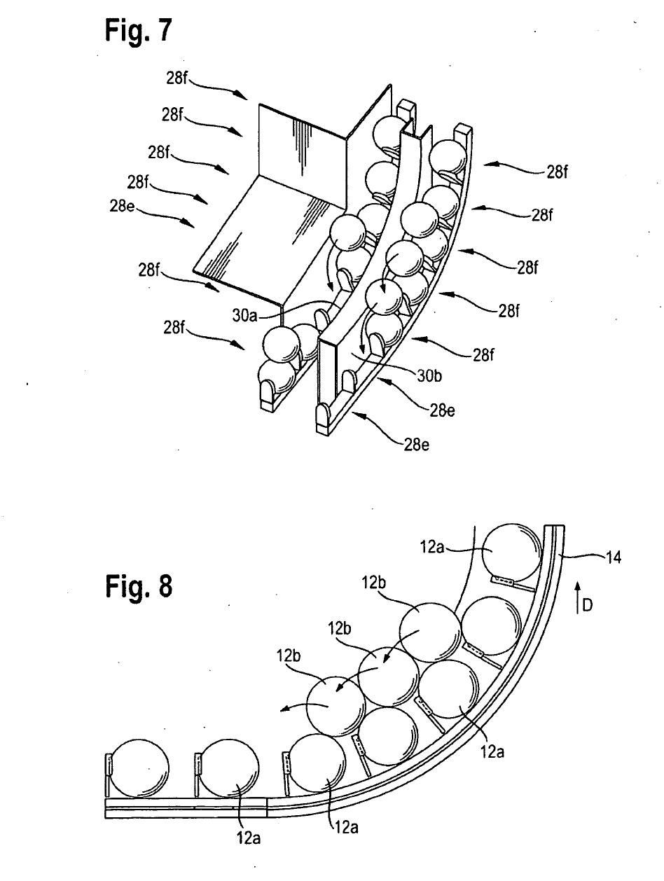

As can be seen in FIGS. 1 and 5-11, the conveyor changes from travelling in a horizontal plane and follows an upwardly directed curve Cᵥ. As shown in FIG. 5, if each of the conveyor sections 28 contained a ball 12, the conveyor follows the path in direction D with each ball passing from being primarily supported on conveyor surface 20 to being supported by support 22. However, it is also typically the case that, as seen in FIGS. 6 and 7, whilst most of the conveyor sections 28 are filled with balls 12, these filled sections being indicated as 28_{f}, some may remain empty, indicated as 28ₑ. As the incline of the conveyor 14 increases along curve Cᵥ, any incorrectly positioned balls 12b will eventually fall from their position under the force of gravity and roll back in a direction opposite to the direction of travel D of conveyor 14. As a result, ball 12b is likely to fall into the empty conveyor section 28ₑ.

As can be seen from FIG. 8, if there is an excess of balls 12 in the collection portion and each of the conveyor sections 28 is filled, the excess balls 12b will continue to fall backwards in the direction away from the direction D of travel of the conveyor 14 until an empty conveyor section is found.

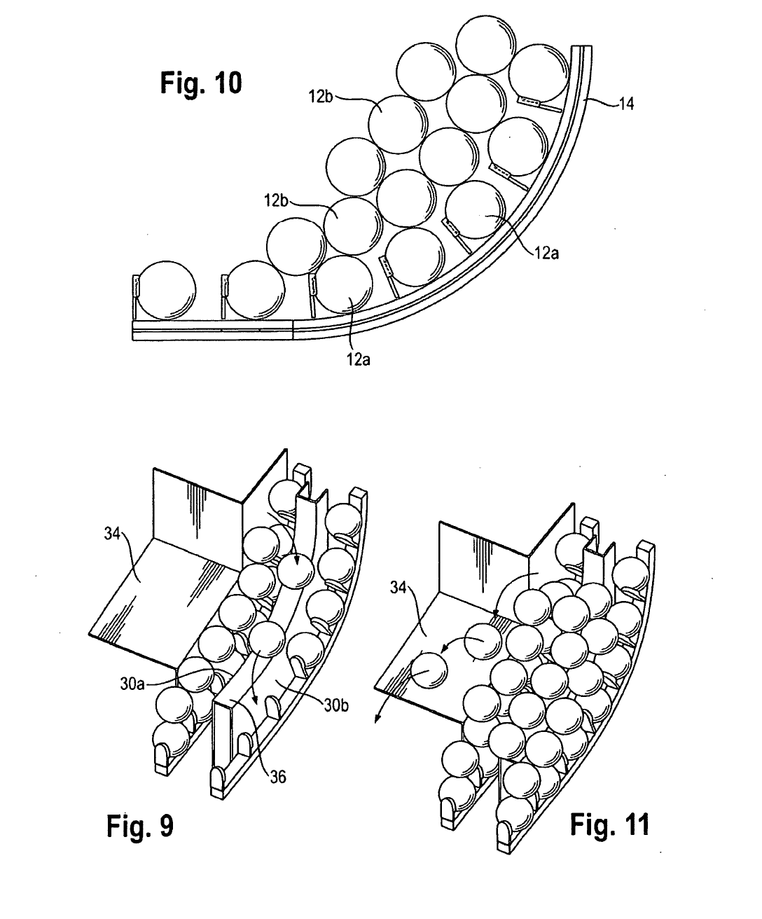

Turning to FIG. 9, in the event that an excess of balls 12 builds up on one conveyor whilst some empty conveyor sections are present in the other conveyor, the excess balls from one side are inclined to transfer to the other conveyor. This is because the walls 30a are slightly higher than the walls 30b which are located between the two conveyors. Therefore before a ball can be pushed back onto inclined surface 34, it is more likely to pass over the connecting surface 36 which joins the two walls 30b and fall into an empty conveyor section 28 in the other conveyor.

FIGS. 10 and 11 show a situation where a large excess of balls has entered the collection portion and all of the conveyor sections 28 are already filled. Under these circumstances the excess of balls piles up above the height of the higher walls 30a and will roll back onto inclined surface 34. As a result these balls will roll back towards the part of the conveyor travelling in a horizontal plane.

Upon leaving the collection portion, the conveyor 14, carrying the balls 12, follows a path which will pass through a number of vertical and horizontal curves, a vertical curve being a curve where the path of the conveyor remains in a vertical plane whilst passing through the curve (previously referred to as Cᵥ) and a horizontal curve being where the path of the conveyor remains in a horizontal plane whilst passing through a curve (previously referred to as Cₕ). An example of a horizontal curve is shown in FIGS. 12-15. As the conveyor 14 follows a curved path at a corner 38, a centrifugal force will cause the ball 12 to move towards the outer wall 40 and the ball is likely to come into contact with that wall 40. As can be seen in FIGS. 12 and 13, this engagement of the ball 12 with the wall 40 will cause the ball to rotate in direction R₁ when the conveyor travels in the direction D as seen on FIG. 13. As a result of the rotation the ball 12 engages the ridge 26 of support 22 at a point of contact 42 which tends to result in the ball jamming against the ridge 26. This in turn resists the movement of the conveyor in direction D requiring that extra power is applied to the conveyor to ensure that the ball travels round the corner 38 and potentially causing damage to the conveyor.

In order to alleviate this problem, the outer wall 40 of curve 38 is provided with two lines of castors 44 which allow the balls 12 to remain rotationally stationary relative to conveyor 14 whilst the castors rotate in direction R₂.

As can be seen in FIG. 15, the curve that the outer wall 40 follows is different from the curve of the path of conveyor 14. This is because, as can be seen in FIG. 15, as the ball 12 passes around the corner 38 the edge of the ball which is likely to engage the wall 40 follows a slightly different path from the conveyor because it is being pushed by the support 22. The conveyor 14 follows the path which is coincident with the path of the centre of the ball 48 until it reaches the curve 38. At that point, whilst the conveyor path can be seen to follow the central line of the conveyor 14, the ball path 48 continues heading linearly towards corner 38 for a short distance. The path 48 then turns the corner but is closer to wall 40 than the conveyor path 48 and continues around the curve rejoining the conveyor path 46 once the conveyor path has already straightened to return to a linear direction. By moving wall 40 slightly further away from the conveyor 14 and by providing it with castors 44 this ensures that the balls 12 can freely pass around horizontal corners.

Although the collection portion 18 of apparatus 10 is designed to consistently provide a ball in each conveyor section 28, it is possible that a section may be left empty and as a result, it is advisable to provide a ball counting device to ensure that the number of balls that are required to be provided in a group are all available as required. If a ball is missing, that group can be rejected and a new group selected.

The apparatus as a whole may consist of two conveyors, one of which passes through the collection portion and from which balls are transferred to a second conveyor which delivers them to a delivery device. In the example shown in FIG. 1, this would result in four conveyors. Two which pass through the collection portion and two which carry the balls onto the delivery device.

The conveyor 14 continues to follow its path until reaching a ball delivery device 50 which removes the ball 12 from the conveyor 14. The timing of delivery of the ball 12 from the conveyor 14 is dependent upon movement of the conveyor and this can be controlled by stopping and starting the conveyor 14 in order to deliver the balls 12 one at a time at the required intervals.

The delivery device includes a direction changer 52 which diverts the ball 12 from following the path of conveyor 14 which is travelling in direction D. The direction changer 52 is formed from two lines of castors 54 which are located on either side of the conveyor 14 and are contained within a pair of walls (not shown) which retain the ball 12 as it is carried by the conveyor 14. In the example shown, the path of conveyor 14 is vertical and therefore the ball 12 is being carried on support 22. A second pair of lines of castors 56 guide the ball 12 as it is diverted from the conveyor 14 towards a run off chute 58.

As ball 12 travels in direction D being carried on support 22 of conveyor 14, it engages a first pair of castors 54a and is moved slightly in direction E which is substantially perpendicular to direction D. This is shown in FIGS. 17b and 18a. As the conveyor continues to move in direction D, the ball 12 engages further pairs of castors, for example in FIG. 11c, castors 54b, 54c and 54d. As the ball continues to move in direction E, it begins to slightly rotate in direction R₃ because a large component of the movement of ball 12 is still in direction D the castors rotate in direction R₄. In FIGS. 17d and 17e, it can be seen that the continuing movement of the conveyor in direction D causes the ball 12 to engage further castors and to move further in direction E until it finally falls from support 22 as seen in FIGS. 17f and 17g. In FIG. 18 it can be seen that the ball 12, as it moves in direction E, begins to engage castors 56. These castors ensure the consistent delivery of the balls 12 from the conveyor 14. If the castors 54 and 56 are not used, and the balls engaged with a fixed surface which will be instead of castors 54 and 56, since the ball cannot freely rotate on the support 22, the ball can stick against such surfaces and will not be delivered in a consistent manner to chute 58. From chute 58 the ball is delivered to a player and the whole delivery device 50 is enclosed so that the conveyor remains out of view of the player.

Referring to FIGS. 19 to 21, a sports apparatus 100 has a processor 102 for receiving input signals 104 from input cable 106 and producing output signals 108 and 110 via output cables 112 and 114. The apparatus also has target indicators in the form of light omitting diodes (LED) 116 which are formed into two rows, as seen in FIG. 21 and are located in walls 118 adjacent the floor 120 of play area 122.

The apparatus 100 also includes sensors 124 which are also located in wall 118 and are positioned in a line which is positioned at a height approximately equal to the average radius of the ball above floor 120. As a result the sensors 124 can detect being hit by a ball which is rolling along floor 120. Typically the sensors 124 include a photosensor which detects changes in the amount of light it receives which can in turn be used to determine if it has been hit by a football hitting. This can either be as a result of a decrease in light as a ball hits the sensor and therefore blocks light being received by the photosensor or can be another change in light where light from LED's 116, or other LED's which closely surround the sensor and may emit light outside of visible wave lengths, reflect light from a ball as it approaches and hits the sensor. This will produce a characteristic output from the photosensor which can be recognised by processor 102 as a ball hitting the sensor 124.

In an alternative embodiment of the sensor each sensor has its own light emitter which produces light with a unique signature, either as a result of a unique frequency or a unique wave pattern. The emitter produces a light close to the sensor which detects a change in the amount of light, carrying that signature, as a ball approaches it or hits it.

A display device 126 acts as a result indicator and can be used to display a score. A console 128 contains processor 102 and is used to identify a player 130 using an RFID card (not shown).

In use, a player 130 approaches the console 128 and identifies themselves using the RFID card. The player 130 then enters the play area 122 and a session using the sports apparatus 100 starts. A group of the LED's 116 are simultaneously lit to indicate a target which is to be hit by a ball. If several adjacent LED's from each line are lit, as a result of output signal 108 from cable 112, this forms a rectangular target area.

A player 130 kicks ball 12 along the surface of floor 120 towards the target indicated by lit LED's 116 on wall 118. When ball 12 hits wall 118 this impact will be detected by sensors 124 in the manner described above. This will result in a signal 104 being sent along cable 106 to processor 102. The processor 102 then determines whether the or each sensor 124 which sent a signal to processor 102 indicating that it, or they, had been hit by the ball 12, corresponded to the target as indicated by the LED's 116 which were lit at that time. If the LED's 116 corresponding to a respective sensor 124 were lit at the time the sensor was hit, that is the LED's adjacent the sensor that was hit were lit, this means that the ball hit the target. This will result in a second output signal 110 being output along cable 114 to display device 126 to indicate that a target has been hit. Typically this indication can be in the form of a number which increases with each time the target is correctly hit.

With two lines of LED's 116, as shown in FIG. 21, a moving target can be created by consecutively turning on and off the LED's 116 in each row so as to create a moving rectangle. It is therefore necessary for the processor 102 to determine whether a sensor 124 was hit when the LED's forming the moving rectangle were lit indicating a hit or whether they were unlit indicating a miss. This moving target is used in the apparatus shown in FIG. 19.

Alternatively, a rectangle of LED's can be lit for a short period of time before being switched off and a different set of consecutive LED's in each line representing a rectangle are lit. The blocks which switch on and switch off are the type used in the apparatus shown in FIG. 20 where both of the walls indicated 118 have rows of sensors which are to be hit by ball 12. As a result player 130 must keep an eye on each wall to determine where to kick the ball 120. In a further alternative the sensors could be located in a small number of discrete targets on each ball and can be located at any reasonable height. An example of this is apparatus is shown in FIG. 20.

Referring to FIG. 22 which shows a similar sports apparatus as that shown in FIGS. 19 and 20 except that the sensors and target indicators are combined into a single sensor/target unit 132, a plurality of which are located in floor 120. The sensor/target unit includes a photosensor which is surrounded by LED's and is typically protected by a transparent Perspex plate. When a ball is rolled over the sensor/target unit 132 a change in signal is received by the processor 102. The object for the player of the apparatus is to roll the ball to a sensor/target unit 132 and stop it on that unit when the LED's are lit. If a ball stopping on a sensor is detected by the processor at the same time, or at approximately the same time, as the LED's being lit the processor sends a signal to the display screen 126.

Referring to FIGS. 23 to 15, in which parts in common of those of FIGS. 19 to 22 are denoted with like reference numerals increased by 100, a sports apparatus 200 includes a processor 202 for receiving an input signal 204 from an input cable 206 and produces an output signal 208 which is sent along an output cable 212. A further output signal 210 can be sent along a second output cable 214 to a display device 226. The apparatus also has targets 234 in the form of mannequins which are supported on retractable support members 236 which allow the targets 234 to be moved between an upright or target position, as seen in FIGS. 23 and 24 and a retracted position where they are invisible, or only partially visible, when viewed in the direction shown in FIG. 23. This retraction is controlled by pneumatic control devices 238 which act to move the targets 234 between the target and retracted positions in response to output signal 208 via output cable 212.

The object for the player of apparatus 200 is to hit the targets 234 which the ball 12 at a significant speed. In order to detect the impact, the sensors 224 ideally include an accelerometer which is able to measure the impact of the ball 12 against the target 234. As the ball 12 hits target 234 the impact causes movement of the target which is measured by the accelerometer 224. The output signal from the accelerometer is sent to the processor 202 as input signal 204 and if this signal indicates that the target was hit with sufficient force the processor sends an output signal 208 along cable 212 to the pneumatic control device 238 which causes the target 234 supported on retractable support member 236 to be retracted. Optionally at the same time an output signal 210 is sent along cable 214 to a display device 226 thereby displaying a score.

As an alternative to the pneumatic control the targets may be raised and lowered by a belt driven by an electrically operated motor. This provides a rigid framework which supports the target and the motor acts as a break when the target is being moved.

As the balls 12 are kicked by players 230 they are collected in a ball sump 240 typically by rolling from incline surfaces such as that shown as 242. The ball sump 242 allows balls to roll under gravity towards the entrance 32 of collection portion 160f ball delivery apparatus 10, as seen in FIGS. 1 to 15. The balls are then conveyed by conveyor 14 to ball delivery apparatus 50 indicated as 250 on FIGS. 23 and 24.

In a soccer themed attraction a player arrives and registers their details which are entered into a computer which is linked to a network also linked to the processors 102 and 202 for each sports apparatus. The players registration details are stored on a RFID card which the player carries with them and on arriving at each game the card is read at a console 228. The player then uses each of the sports apparatus shown in FIGS. 19, 20, 22 before moving onto a final use of the apparatus shown in FIGS. 23 and 24.

It will be appreciated by persons skilled in the art that the above embodiment has been described by way of example only and not in any limitative sense, and that various alterations and modifications are possible without departure from the scope of the invention as defined by the appended claims.

1-39. (canceled)

40. An apparatus for delivering balls, the apparatus comprising:
at least one conveyor for conveying a plurality of balls, the or each conveyor following a respective path;
at least one collection portion for receiving said balls wherein said path at least partially passes though said collection portion at an angle inclined to the horizontal, said collection portion comprising at least one ball travel limiting device for preventing a ball from leaving said collection portion unless it is correctly engaged with said conveyor.

41. An apparatus according to claim 40, wherein said conveyor comprises a plurality of supports connected thereto for supporting and/or guiding said balls.

42. An apparatus according to claim 40, wherein said at least one ball travel limiting device comprises a portion of said path, within said collection portion, wherein said angle of said path in said portion increases such that said balls fall from said conveyor unless they are correctly engaged with said conveyor.

43. An apparatus according to claim 40, wherein at least part of said portion of said path passing through said collection portion follows a substantially curved path with the angle of inclination changing from substantially horizontal to substantially vertical

44. An apparatus according to claim 40, further comprising a pair of conveyors adapted to follow respective paths wherein at least a portion of said paths passing through said collection portion are separated by a first wall.

45. An apparatus according to claim 44, further comprising second walls aligned substantially parallel to the path of said conveyor through at least part of said collection portion, wherein at least part of said second walls are taller that an equivalent portion of said first wall.

46. A method of delivering balls, comprising the steps of:
receiving in a collection portion of an object delivery apparatus a plurality of balls;
conveying at least one conveyor along a path passing at least partially through said collection portion at an angle inclined to the horizontal; and
preventing a ball from leaving said collection portion unless it is correctly engaged with said conveyor.

47. A method according to claim 46, wherein said balls are prevented from leaving said collection portion, by increasing said angle along said path such that said balls fall from said conveyor unless they are correctly engaged with said conveyor.

48. A method according to claim 46, wherein said portion of said path passing through said collection portion follows a substantially curved path with the angle of inclination changing from substantially horizontal to substantially vertical.

49. A ball delivery device apparatus comprising:
at least one conveyor for conveying at least one ball, the conveyor following a first path;
at least one direction changer for diverting the or each ball from following said first path, at least one said direction changer comprising at least one first rotatable ball engaging member positioned to direct said ball from said first path; and
at least one delivery device for delivering the or each ball.

50. An apparatus according to claim 49, wherein said delivery device comprises at least one chute.

51. An apparatus according to claim 49, further comprising at least one second rotatable ball engaging member adapted to engage the or each ball as they leave said conveyor and pass to said delivery device.

52. An apparatus according to claim 49, wherein at least one conveyor comprises at least one support for guiding and/or supporting a respective ball.

53. An apparatus according to claim 49, wherein at least one said rotatable ball engaging member comprises a plurality of casters.

54. An apparatus according to claim 53, wherein at least one said first rotatable ball engaging member comprises a pair of lines of casters aligned on either side of said conveyor.

55. A method of delivering balls comprising the steps of:
conveying at least one ball on a conveyor, the conveyor following a first path; and
diverting the or each ball from following said first path, using at least one said direction changer comprising at least one first rotatable ball engaging member positioned to direct said ball from said first path.

56. A method according to claim 55, wherein the or each ball is diverted to at least one chute.

57. A ball delivery device comprising:
at least one feed device for feeding a plurality of balls to a collection portion;
at least one first ball delivery apparatus according to claim 40;
wherein said conveyor conveys said balls from at least one said first delivery apparatus to at least one second ball delivery apparatus.

58. A ball delivery device comprising:
at least one feed device for feeding a plurality of balls to a collection portion;
at least one second ball delivery apparatus according to claim 49;
wherein said conveyor conveys said balls from at least one said first delivery apparatus to at least one second ball delivery apparatus.

59. A sports apparatus comprising:
at least one processor for receiving at least one input signal and producing at least one output signal;
at least one target indicator for indicating at least one target to be engaged by at least one ball, the or each target indicator indicating said target in response to at least one output signal from at least one said processor;
at least one sensor for sensing said sensor, or an area adjacent said sensor, being engaged by at least one ball and said sensor thereby producing at least one first input signal;
at least one result indicator for indicating at least one result in response to at least one second output signal from said processor, wherein said processor produces said second output signal dependent upon at least one said first input signal and at least one said first output signal.

60. An apparatus according to claim 59, wherein at least one target indicator and at least one sensor are located on a vertical surface.

61. An apparatus according to claim 59, wherein at least one target indicator and at least one sensor are located on a horizontal surface.

62. An apparatus according to claim 59, wherein at least one target indicator comprises at least one light emitting device which emits light in response to said first output signal.

63. An apparatus according to claim 59, wherein at least one said sensor is adapted to produce at least one said input signal in response to a ball being rolled over it.

64. An apparatus according to claim 59, wherein at least one said sensor is adapted to produce at least one said input signal in response to a ball being hit against it.

65. An apparatus according to claim 59, wherein at least one sensor produces at least one said input signal in response to a change in the amount of light received by said sensor being altered by the position of a ball relative to said sensor.

66. An apparatus according to claim 59, wherein at least one result indicator comprises at least one light emitting device.

67. An apparatus according to claim 59, wherein at least one said target indicator and at least one said result indicator comprise at least one respective light emitting device.

68. An apparatus according to claim 59, wherein at least one said target indicator comprises at least one visual display device adapted to display a score.

69. An apparatus according to claim 59, wherein at least one said processor produces at least one said second output signal if said first input signal is received from at least one sensor corresponding to at least one respective target indicator which has received at least one first output signal within a predetermined time.

70. A sports apparatus comprising:
at least one processor for receiving at least one input signal and producing at least one output signal;
at least one target adapted to be hit by at least one ball and adapted to move between at least one first position and at least one second position in response to at least one output signal from said processor;
at least one sensor for sensing at least one ball hitting a respective target and said sensor thereby producing at least one first input signal;
wherein said processor produces said output signal dependent upon at least one said first input signal.

71. An apparatus according to claim 70, wherein at least one said sensor comprises at least one accelerometer.

72. An apparatus according to claim 70, wherein said first position is an extended position and said second position is a retracted position.

73. A sports apparatus comprising:
at least one ball delivery apparatus according to claim 57.

74. A sports apparatus comprising:
at least one ball delivery apparatus according to claim 58.

75. A sports apparatus comprising:
at least one sports apparatus according to claim 70.
